(19) United States
(12) Patent Application Publication
(10) Pub. No.: US 2006/0116938 A1
(43) Pub. Date: Jun. 1, 2006

(54) Method for the electronic payment of a merchandise or service by using a mobile radio network, and arrangement for carrying out said method

(75) Inventors: Axel Findling, Munchen (DE); Matthias Glatzer, Munchen (DE); Per Vindeby, Munchen (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/519,921

(22) PCT Filed: Jun. 11, 2003
(86) PCT No.: PCT/EP03/06136

§ 371 Date: Oct. 12, 2005

(30) Foreign Application Priority Data
Jul. 3, 2002 (EP) 02014720.3
Jul. 3, 2002 (DE) 102 29 901.3

(51) Int. Cl. G07F 19/00; G07B 17/00

(52) U.S. Cl. 705/30

(57) ABSTRACT

The invention relates to a method allowing a client to electronically pay at least a minimal amount for a merchandise or service to a retailer by using a data network and/or telecommunication network with the aid of an accounting system server. An unambiguous process identifier is generated for the payment process or the series of payment steps and is transmitted at least during a first payment step in a confirmation request from the accounting system server to a client terminal along with information on the amount to be paid.

### CLAIM FOR PRIORITY

This application is a national stage of PCT/EP2003/006136, published in the German language on Jan. 15, 2004, which claims the benefits of priority to European Application No. 02014720.3, filed on Jul. 3, 2002 and German Application No. DE 102 29 901.3, filed on Jul. 3, 2002.

### TECHNICAL FIELD OF THE INVENTION

The invention relates to a method for the electronic payment of goods or services and a suitable arrangement for implementing the method.

### BACKGROUND OF THE INVENTION

As well as being used as a communication tool and information source by hundreds of millions of people at present, the internet is also becoming an increasingly important purchasing source. A significant proportion of trade in software, books and travel currently operates via the internet, but a wide range of other goods and services are also ordered and paid for via the internet. Payment for corresponding services using the internet in the originally established and still most widely used fashion requires that the relevant data records are input separately at least for every business partner if not for each individual transaction. This payment method thereby allows the business partner to access sensitive personal data and even allows them to store it in the long term.

In the meantime, the internet has also become a significant tool for handling other payment processes, both business and private. Almost all banks in industrialized countries offer electronic banking for the electronic handling of account management and payment processes.

The requirements for electronic payment methods differ tremendously for the different situations. This applies both to internet payment methods and to mobile payment methods based for example on SMS, WAP and USSD.

Suitable methods are required, in particular, for so-called micro-payment. These are invoices for small amounts (typically less than EUR 5.00), which cannot generally be processed in a cost-effective manner using existing electronic payment methods, e.g. direct debit. Also micro-payment processes often comprise a plurality of individual small transactions rather than a single transaction (e.g. filling a shopping basket when shopping online). In the future, an increasing number of services on the internet will be charged for, e.g. web content, whereby the costs are a function for example of the volume of data transferred or the number of downloaded pages. Costs/charges are therefore continuously incurred as with a telephone call. When charging for content the costs are generally not a function of time but a function of user behavior. Time-based charges are however also possible in principle.

When making a telephone call, users do not generally have to authorize payment. It is assumed that as soon as a user dials a number on their telephone, they agree automatically to the telephone provider charging it to their account. This is generally not a problem, as a relationship of trust and also a correspondingly structured contractual relationship exists between the user and the telephone service provider.

This is not, however, always the case with e-commerce. Users can come across an arbitrary service of interest to them, the use of which has to be paid for, by chance on the internet. Since, in this case, there is no relationship of trust, the user first has to agree to a payment. In other words said user either confirms it (e.g. with OK) or authorizes it (with a PIN). Users do not, however, want to do this for each one of a series of charges. For one thing this is a lengthy process for the user and for another it is unacceptable for some services, such as streaming audio/video, as the audio/video might possibly have to be interrupted for each charge.

The technical problem essentially involves developing a method which satisfies the above points:
Universality: same basic principle for different access methods, e.g. web, SMS and WAP.
Supports continuous charging, whereby the user can determine in a flexible, service-specific and direct fashion whether and when the next confirmation/authorization should take place.
Stipulation of the next confirmation/authorization must remain confidential as far as the retailer is concerned.
It must be possible for the user to make payments anonymously in respect of the retailer.
The operation must be organized as simply as possible.
The operation must be organized so that it is secure in respect of various attacks.

European patent application 00 121 482.4 (published as EP 1 193 658 A1) deals with this basic problem.

The publication describes how a money sender can transmit an electronic amount of money anonymously to a money recipient using a recipient ID (RID)—which is hereafter referred to as a session ID (SID) (for consistency of description). This allows the customer to remain anonymous in respect of the PSP (Payment Service Provider) and the retailer. The method is shown in a simplified fashion in FIG. 1 and the brief description which follows:

The retailer transmits the amount of money to be paid (1) to the PSP and receives a unique session ID (SID) (2) back. The retailer transmits the SID to the customer, e.g. verbally at a POS (point of sale) (3). The customer sets up a connection to the PSP and transmits the SID (3), as a result of which the customer can also be identified at the same time from their MSISDN. The PSP sends back the associated amount to be paid (5) and the customer confirms payment with a PIN (6). The retailer is notified of the SID as confirmation of payment.

In a so-called pre-confirm method, i.e. a customer can confirm in advance a larger (or even smaller) amount than the retailer requires. This means that the retailer can make subsequent charges without the customer having to provide repeated and inconvenient confirmation. As customers themselves specify the maximum amount, they can determine the payment in a very flexible manner. They only have to confirm the payment again when the previously confirmed amount has been used up.

A brief description of this method is given below and in FIG. 2 with reference to its essential steps:

The retailer wishes to charge an amount of $1 to the customer via the PSP (1). The PSP verifies that the pre-confirm account $ is adequate. If not the customer must confirm the amount with a PIN (2, 3). The customer can also confirm a larger amount ($2) and the pre-confirm account is adjusted accordingly. The amount $1 is confirmed to the retailer (4). When payment is next requested (5), the pre-confirm account is adequate so the amount can be confirmed immediately (6). These steps are repeated until the pre-confirm account is no longer adequate and the user must confirm again.

The above-mentioned first method is very significantly oriented towards real POS, e.g. shops or vending machines, and prepaid accounts. The basic principle can thereby be extended with SID in a relatively simple manner to support other scenarios (e.g. web, WAP, SMS). Also pre-confirm can be set up on the basis of SID. The method only takes into account the situation where servers are operated by mobile radio operators. The second method mentioned above needs to be set out more specifically with regard to how it is actually set up.

### SUMMARY OF THE INVENTION

The invention provides an electronic payment method and corresponding arrangement, which has been worked out in practice and is particularly tailored to the requirements of micro-payment.

The invention resolves the above-mentioned technical problems based on the following premises:
It is ensured on the basis of a session ID (SID) that the customer can (but does not have to) remain anonymous in respect of the retailer (service provider).
The SID also enables the customer to allow the retailer to make continuous charges without the customer having to confirm/authorize the payment.
The limit of the maximum total charge can be set by the customer in a flexible and service-specific manner.
The method supports a very wide range of access methods for the customer, e.g. WEB, WAP, SMS and voice/DTMF. It can be used both on the internet and at POS (points of sale). The interface between the retailer and PSP is typically provided via standard data lines.

The method comprises the following steps in an expedient implementation; see also FIG. 3 and the diagrams of exemplary embodiments in FIGS. 4 to 7 and the corresponding sections of the description below.

1) Customer wants to use a retailer's service, e.g. to request WAP content, pay for goods in a web shop or at a POS.

1a) If the retailer was able to identify the customer and determine an SID assigned to the customer, the retailer can provide this in step 2).

2) The retailer sends a charge request with an SID (if available), the amount to be paid (AmountX), the retailer ID and a context (what was bought) to the PSP.

3) The following distinctions are made here:
If no SID was provided at 2), the PSP sends a unique SID back to the retailer. Steps 3a to 3f then follow.
If an SID was provided at 2), with which no charge could be made (e.g. because the customer has to authorize payment first), the SID or alternatively a new SID is returned. Steps 3a to 3f then follow.
If an SID was provided at 2), with which a charge could be made, the charge is confirmed to the retailer. Step 4 then follows.

3a) If the verification was negative at 3) (i.e. no charge possible), the PSP notifies the retailer of an SID.

3b) The retailer notifies the customer of the SID. In the case of WAP and WEP this can be achieved as a parameter in a redirect from the customer to the PSP, in the case of SMS the retailer can send the customer an SMS containing the SID. At a POS the SID can also be communicated verbally.

3c) The customer forwards the SID to the PSP. In the case of WEB and WAP this can be done automatically, i.e. no input is required from the customer (redirect). In the case of SMS the customer can forward the SMS from the retailer containing the SID to the PSP. In the case of voice/DTMF the customer generally has to call the PSP and communicate the SID via DTMF.

3d) The PSP notifies the customer of the required amount (Amount X), the retailer name and context (e.g. via WEB, WAP, SMS or voice).

3e) The customer identifies themselves, e.g. automatically via their MSISDN or by inputting their ID. The customer can also change (AmountY) the required amount (AmountX), e.g. increase it for advance confirmation of subsequent payments. The customer can also confirm/authorize the payment (e.g. PIN).

3f) Verification of customer profile and liquidity.

4) The PSP carries out the necessary verifications of the payment.

5) As an option the PSP can confirm the payment (AmountX) to the customer (e.g. by SMS).

6) The PSP confirms the posting of the amount to the retailer.

7) The retailer sends the goods to the customer.

In the case of connection-related operations with WAP and WEB, for example, the communication relationship switches from customer⇄retailer first to customer⇄PSP typically on the basis of connection redirect. So that the customer can use the required service from the retailer again after payment, a redirect takes place from the PSP back to the retailer. These redirects are implementation-specific and are therefore not shown in the sequence.

After advance confirmation of an adequate amount a charge comprises steps 2), 3), 4) and 6) and can therefore be processed very efficiently. The advance confirmation of an amount does not have to be directly related to a purchase. The customer can for example confirm an adequate amount for an SID in advance, for example to pay at parking meters. If the retailer records the assignment between customer and SID, steps 3a to 3f can be omitted for future payments. Identification of the customer can for example be based on the MSISDN of an SMS or an ID at login. It is important here that the user ID for the retailer is independent of the user ID for the PSP. There are therefore no dependencies and the retailer does not have to know the user ID of the customer for the PSP.

A customer has the option of having a list of their valid SIDs displayed for the PSP. As well as the SID, associated data such as the amount still available and the associated retailer can be displayed. Selected SIDs (at the PSP) can also be deleted, e.g. via WEB, WAP and SMS. After deletion of the SID the retailer cannot make any further charges without involving the customer. The entire operation then has to be carried out before a charge can be made again (e.g. request SID and confirm payment).

The PSP does not have to manage the actual accounts and administer the money of the customer and retailer. The PSP can for example have interfaces with a clearing house, which deals with the clearing and settlement of the accounts.

The method has the following advantages:
The basic principle of the method is identical for the different access methods (e.g. web, WAP, SMS, etc.). This simplifies the setting up of the payment system, the use of the method for retailers and customers without restricting flexibility.
The method supports both individual charges and continuous charging. The latter is primarily of importance for content charging, where charging is for example volume-based (pay per click) or even time-based.
Cost control: The customer can confirm amounts in advance in a service-specific manner and thereby avoid inconvenient posting confirmation/authorization.
With amounts confirmed in advance charges can be implemented very quickly. In a simple instance the customer has to send the retailer an SMS to obtain a drink from a vending machine, for example.
High level of security: The customer does not have to give the retailer any confidential or payment-related data, e.g. PIN or account number.
The customer can remain anonymous in respect of the retailer.

It should be noted specifically that advantageous embodiments of the method specified in the dependent method claims should also all be understood as embodiments of the suitable arrangement for implementing said method, whether in hardware or software form.

### BRIEF DESCRIPTION OF THE DRAWINGS

The invention is described below with reference to exemplary embodiments, which are examined in more detail with reference to diagrams, in which:

FIG. 1 shows the sequence of a known electronic payment method.

FIG. 2 shows an electronic payment method which is the subject of a prior patent application.

FIG. 3 shows a block diagram with method steps marked for associated clarification of essential aspects the invention.

FIG. 4 shows a block diagram of a first embodiment of the invention.

FIG. 5 shows a block diagram of a second embodiment of the invention.

FIG. 6 shows a block diagram of a third embodiment of the invention.

FIG. 7 shows a block diagram of a fourth embodiment of the invention.

### DETAILED DESCRIPTION OF THE INVENTION

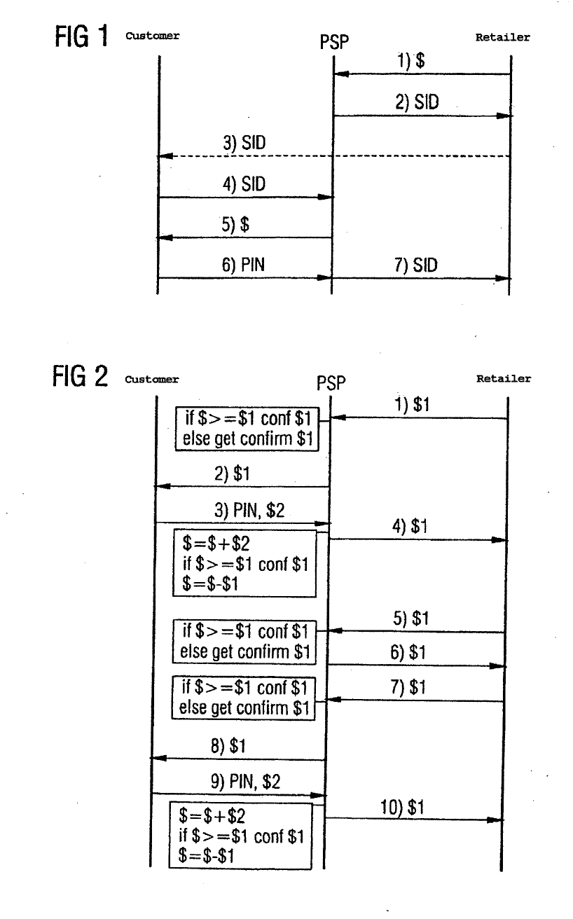

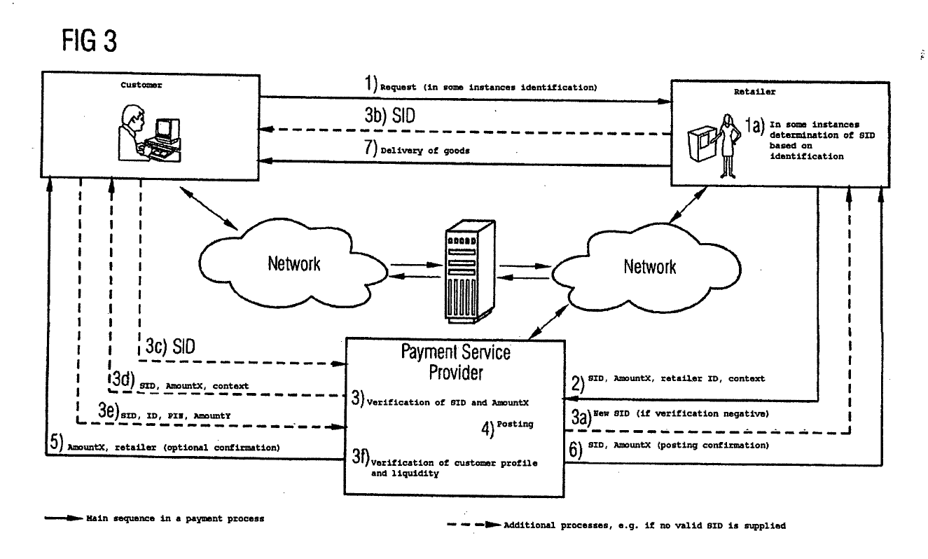

With regard to FIGS. 1 and 2 reference should be made to the explanation of the prior art in the introductory part of the specification; with regard to FIG. 3 to the explanation of an expedient implementation above.

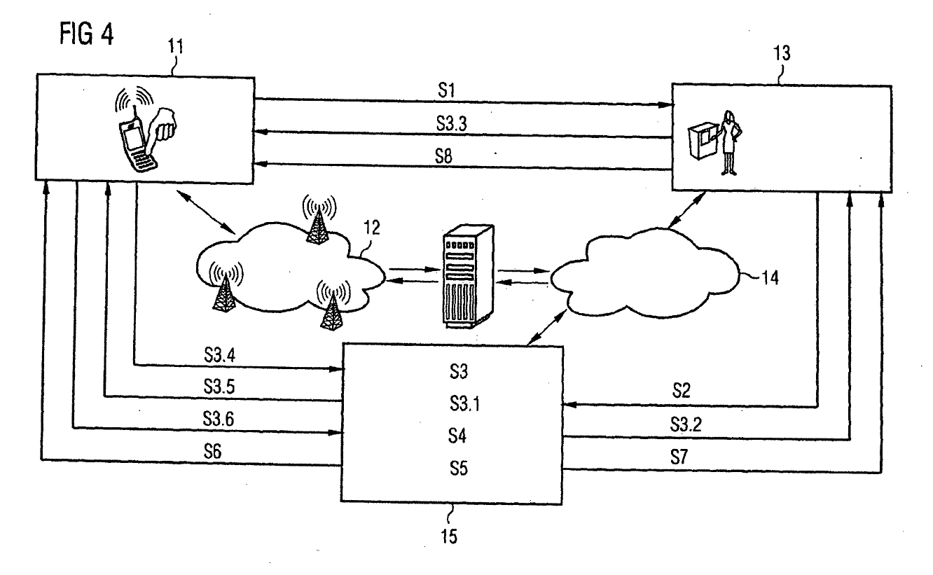

FIG. 4 shows a first posting process for the first retrieval of a chargeable WAP content by the purchaser from a provider. In S1, a request is sent from the WAP-capable terminal (e.g. mobile telephone) 11 of the purchaser via a GSM telecommunication network 12 to the server 13 of a provider. In S2, the vendor transmits the transaction data, which comprises the ID of the vendor, the designation and invoice total of EUR 1 for the WAP content, via a data network 14 to the server 15 of a Payment Service Provider (PSP).

As after verification of the transaction data in S3 no session ID (SID) assigned to the purchaser was determined, a unique SID is now generated on the server 15 of the PSP by S3.1 and transmitted in S3.2 to the server 13 of the provider, where it is stored. This is sent in S3.3 as a parameter in the URL of a WAP redirect to the mobile telephone 11 of the purchaser, whereby the SID is automatically transmitted to the server 15 of the PSP in S3.4 in the context of the WAP redirect. Then in S3.5 the ID of the vendor, the designation and invoice total of EUR 1 for the WAP content are sent from the server 15 of the PSP to the mobile telephone 11 of the purchaser. In S3.6 the purchaser is identified from the known MSISDN of the mobile telephone by means of a WAP-GW request and authorization of a credit of EUR 3 is also effected with a PIN.

In S4 the credit amount is assigned to the transaction account associated with the SID on the server 15 of the PSP and the invoice total is posted to the transaction account and, after verification of the purchaser profile in S5, in S6 a posting conformation, including the invoice total of EUR 1 and the retailer ID, is sent to the mobile telephone 11 of the purchaser. After transmission of the posting confirmation from the server 15 of the PSP to the server 13 of the provider in the form of SID and invoice total for the WAP content in S7, in S8 release is given for transmission of the WAP content to the mobile telephone 11 of the purchaser.

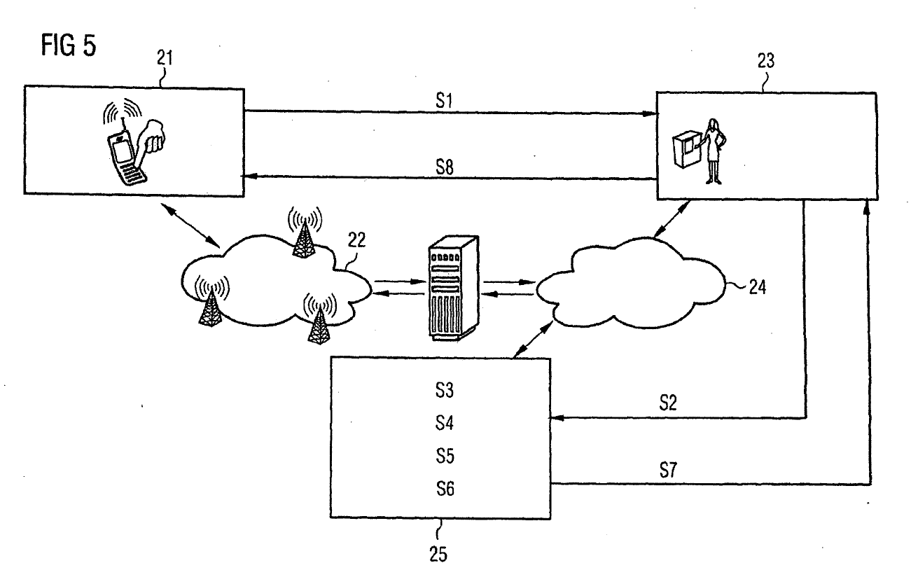

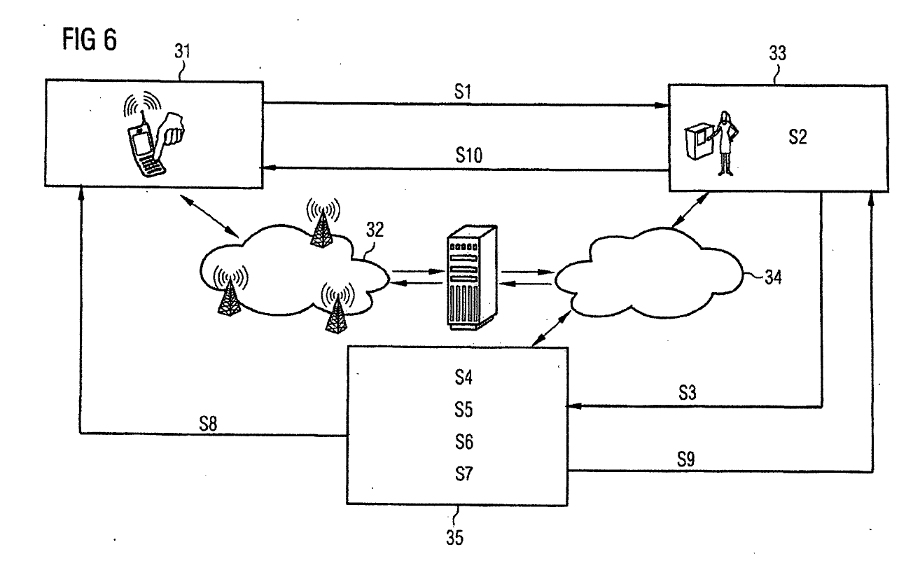

FIG. 5 describes a posting process for a chargeable WAP content, as might follow the example in FIG. 4. In step S1 a further request is sent from the mobile telephone 21 of the purchaser to the server 23 of the provider, who in S2 transmits the transaction data, comprising the vendor ID, the designation and invoice total of EUR 1 for the WAP content and SID to the server 25 of the PSP. After positive verification of the transaction data or SID, the credit amount and the customer profile in S3 to S5, in S6 the invoice total is posted to the transaction account on the server 25 of the PSP. When the posting confirmation has been sent S7 to the server 23 of the provider, in S8 release is given for transmission of the WAP content to the mobile telephone 21 of the purchaser. FIG. 6 shows the use of a chargeable service based on SMS, whereby in S1 a request is sent from the mobile telephone 31 of the purchaser via a mobile radio network 32 to the server 33 of the vendor. In S2, the MSISDN/mobile telephone number is used to determine the SID assigned to the purchaser and in S3 the SID is transmitted along with the other transaction data (vendor ID, designation and invoice total of EUR 1) via a data network 34 to the server 35 of the PSP. After positive verification of the transaction data or SID, the credit amount and customer profile in S4 to S6, in S7 the invoice total is posted. Based on an instruction lodged in the customer profile, in S8 confirmation of the posting of the invoice total of EUR 1 is sent from the server 35 of the PSP to the mobile telephone 31 of the purchaser. In S9, the posting confirmation is sent to the server 33 of the vendor and then in S10 the vendor transmits the chargeable SMS to the customer.

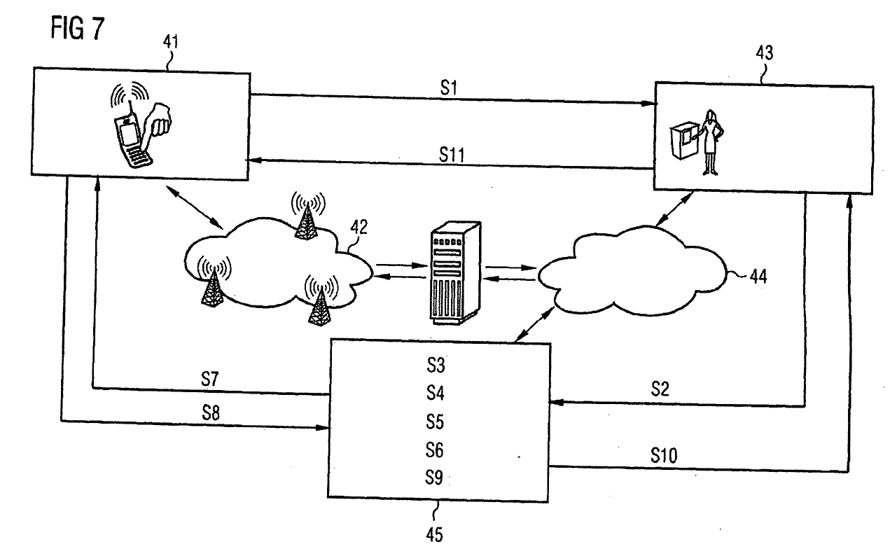

FIG. 7 shows a further example based on SMS, whereby S1 (request for a chargeable service) to S6 (verification of customer profile) operate in the same way as FIG. 5. In the present case, a posting authorization is lodged in the customer profile so that in S7 the transaction data is sent from the server 45 of the PSP to the mobile telephone 41 of the purchaser. In S8, the posting is authorized by transmission of the invoice total, SID and PIN to the server 45 of the PSP and the posting is then carried out in S9. After transmission of the posting confirmation to the server 43 of the vendor in S10, in S11 the chargeable SMS is transmitted from the vendor to the customer. The embodiment of the invention is not restricted to the descriptions given as examples above but includes a plurality of modifications which are within the scope of action by persons skilled in the art.

What is claimed is:

1. A method for the electronic payment implemented in a series of payment steps by a customer to a retailer using a data and/or telecommunication network and involving an accounting system server, comprising:
generating a unique process identifier by the accounting system server for the payment and being transmitted at least in a first payment step in a confirmation request from the accounting system server, together with payment amount information, to a customer terminal;
transmitting a confirmation message from a customer terminal via the data or telecommunication network to the accounting system server to release at least a partial credit for the payment amount for payment in assignment to the process identifier;
comparing, on the accounting system server, of the at least partial credit of the customer registered with the accounting system server and available for electronic management thereby with the payment amount released by the customer; and
further to the establishment of a credit amount exceeding the released payment amount by the accounting system server in response to the confirmation message, charging the released payment amount or a partial amount to be paid being triggered by this and sending a first execution message relating to the completed charge to a retailer terminal.

2. The method according to claim 1, wherein the process identifier is generated in assignment to a customer identifier by the accounting system server and transmitted in advance to the retailer in response to a request message transmitted from the retailer terminal.

3. The method according to claim 2, wherein the process identifier is sent electronically in an identifier notification from the accounting system server to the retailer terminal.

4. The method according to claim 1, wherein a second payment step and any additional steps of an associated series of payment steps are executed in each instance by
transmission of a step-related payment amount in assignment to the process identifier to the accounting system server,
verification of the step-related payment amount in relation to a payment amount remaining from the released payment amount and
charging further to the establishment of a step-related payment amount less than the remaining payment amount and sending a further execution message to the retailer terminal.

5. The method according to claim 4, wherein in the second payment step or additional steps in the result of the establishment of a step-related payment amount exceeding the released remaining payment amount, a confirmation request is sent by the accounting system server to a customer terminal with the original or a new process identifier and payment amount information with a payment amount at least covering the difference between the step-related payment amount and the remaining payment amount and charging of the step-related payment amount is only triggered after receipt of a corresponding confirmation message from the customer terminal.

6. The method according to claim 5, wherein the payment amount specified in the confirmation request for confirmation is substantially larger than a difference between the step-related payment amount and the remaining payment amount, such that further to a confirmation message for the payment amount, a new remaining payment amount is released for a plurality of subsequent payment steps in the accounting system server.

7. The method according to claim 1, wherein each message from the retailer terminal or the accounting system server includes a retailer identifier and a context data record identifying the goods or service.

8. The method according to claim 1, the process identifier is transmitted to the retailer terminal by email or SMS.

9. The method according to claim 1, wherein the customer is notified of the process identifier at a point of sale outside the data or telecommunication network.

10. The method according to claim 1, wherein the confirmation request is transmitted from the accounting system server to the customer terminal via email, WAP push, SMS or as a synthetic voice message.

11. The method according to claim 1, wherein the confirmation request from the accounting system server to the customer terminal includes a retailer name and a context data record identifying the goods or service.

12. The method according to claim 1, wherein the confirmation message is sent from the customer terminal to the accounting system server by email redirect, WAP redirect or SMS redirect without additional input on the part of the customer.

13. The method according to claim 1, wherein the confirmation message is sent from the customer terminal to the accounting system server by voice message subject to subsequent voice ID or by DTMF.

14. The method according to claim 1, wherein the confirmation message from the customer terminal to the accounting system server includes a customer identifier that is automatically generated or input by the customer and optionally also an authentication code.

15. The method according to claim 1, wherein the accounting system server sends a second execution message to the customer terminal in addition to the first execution message to the retailer terminal.

16. An arrangement for the electronic payment, comprising: an accounting system server of an accounting system operator;
a customer terminal linked to a data and/or telecommunication network, which can be connected via the network to the accounting system server; and
a retailer terminal linked to the data and/or telecommunication network or a further communication network, which can be connected via the network to the accounting system server,
wherein the accounting system server has a generating device for generating and sending a confirmation request to the customer terminal, a receiving device for receiving a confirmation message from the customer terminal and for extracting at least the process identifier and a released payment amount from this, a storage device for customer-related storage of the credit amount and for process-related storage of the released payment amount, a comparison device for comparing the credit amount with the payment amount and control and a transmission device connected to the comparison device to trigger the charge and to send the execution message to the retailer terminal.

17. The arrangement according to claim 16, wherein the customer terminal is configured as a mobile radio terminal and the data and/or telecommunication network has a mobile radio network, and a mobile radio transmission/receiving device is assigned to the accounting system server for bi-directional mobile radio communication with the customer terminal.

18. The arrangement according to claim 17, wherein the generating device for generating the process identifier and the transmission device are connected to for transmission thereof to the retailer terminal.

19. The arrangement according to claim 16, wherein the accounting system server further comprises a calculation device to calculate the remaining payment amount from a stored released payment amount and at least one step-related payment amount and the storage device is connected to the calculation device to store the remaining payment amount in place of the released payment amount as input data for the comparison device.

20. The arrangement according to claim 16, wherein the accounting system server has an identification and storage device for extracting a retailer identifier and/or customer identifier from messages from the retailer terminal or customer terminal and a storage and addressing device for addressing the confirmation request and/or execution message and optionally further messages to the customer terminal or retailer terminal based on the stored retailer identifier or customer identifier.
